(19) United States
(12) Patent Application Publication
(10) Pub. No.: US 2015/0053444 A1
(43) Pub. Date: Feb. 26, 2015

(54) HITCH ASSEMBLY FOR AN AGRICULTURAL IMPLEMENT USING HARDENED PINS

(71) Applicant: CNH Industrial America LLC, New Holland, PA (US)

(72) Inventors: Michael G. Kovach, Morton, IL (US); Rick L. Gerber, Roanoke, IL (US)

(73) Assignee: CNH Industrial America LLC, New Holland, PA (US)

(21) Appl. No.: 14/450,713

(22) Filed: Aug. 4, 2014

Related U.S. Application Data
(60) Provisional application No. 61/868,138, filed on Aug. 21, 2013.

(51) Int. Cl. A01B 59/00; A01B 59/042

(52) U.S. Cl. CPC A01B 59/002; A01B 59/042
USPC 172/677

(57) ABSTRACT

An agricultural implement includes a pull frame extending forward from the implement. A pull hitch is attached to a front end of the pull frame and includes at least one pair of aligned openings. A clevis includes at least one pin opening. A pin extends through each pair of aligned openings in the pull hitch and a corresponding pin opening in the clevis.

### CROSS REFERENCE TO RELATED APPLICATIONS

This is a non-provisional application based upon U.S. provisional patent application Ser. No. 61/868,138, entitled “HITCH ASSEMBLY FOR AN AGRICULTURAL IMPLEMENT USING HARDENED PINS”, filed Aug. 21, 2013, which is incorporated herein by reference.

### BACKGROUND OF THE INVENTION

1. Field of the Invention

The present invention relates to agricultural implements, and, more particularly, to hitch assemblies for such implements.

2. Description of the Related Art

Agricultural implements such as disks, field cultivators, harrows, etc experience large loads on the hitch assembly which is used to tow the implement. These types of implements are used to till or finish the soil prior to seeding. Depending on such variables as implement width, soil type, tillage or finishing depth, etc, the loads placed on the hitch can be considerable. The implement width tends to become wider and wider over time, which increases the loads on the hitch assembly.

A typical hitch assembly for a large implement may include a pull frame which extends forward from the implement in an operating direction of travel of the implement. The pull frame usually includes a pair of frame members extending forward from the implement with a generally “V” configuration to withstand lateral loads as the implement is turned. The pull hitch is positioned at the front or apex of the V configuration, and usually includes a clevis which is attached directly to the draw bar extending rearwardly from the traction unit (e.g., tractor). The clevis is bolted to the pull hitch. However, with very large loads placed on the hitch assembly caused by wide tillage or finishing implements, the bolts may break or shear, even if hardened bolts are used. Moreover, the bolts are not as easy to assemble and require the use of a torque wrench to ensure that proper pre-loads are placed on the bolts. It is sometimes necessary to place shims between the clevis and the pull hitch in order to maintain a proper torque and pre-load on the bolts.

What is needed in the art is a hitch assembly which can be used with wide tillage or finishing implements, that is stronger than conventional hitch assemblies, and easier and faster to assemble.

### SUMMARY OF THE INVENTION

The present invention provides a hitch assembly that uses case hardened pins, rather than bolts, providing a stronger hitch assembly that is also faster and easier to assemble.

The invention in one form is directed to an agricultural implement including a pull frame extending forward from the implement. A pull hitch is attached to a front end of the pull frame and includes at least one pair of aligned openings. A clevis includes at least one pin opening. A pin extends through each pair of aligned openings in the pull hitch and a corresponding pin opening in the clevis.

The invention in another form is directed to a pull hitch assembly for an agricultural implement. The implement includes a pull frame for pulling the implement with a traction unit. The pull hitch assembly includes a pull hitch for attachment to a front end of the pull frame. The pull hitch includes at least one pair of aligned openings. A clevis includes at least one pin opening. A pin extends through each pair of aligned openings in the pull hitch and a corresponding pin opening in the clevis.

An advantage of the present invention is that the hardened pins provide a much stronger hitch assembly.

Another advantage is that the pins are easier to assemble and do not require the use of a torque wrench, as is the case if bolts were used.

Yet another advantage is that no shims are needed between the clevis and the pull hitch in order to maintain a proper torque and pre-load on the bolts.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a portion of an agricultural implement including an embodiment of a hitch assembly of the present invention;

FIG. 2 is a perspective view of the hitch assembly shown in FIG. 1; and

FIG. 3 is an exploded perspective view of the hitch assembly shown in FIGS. 1 and 2.

Corresponding reference characters indicate corresponding parts throughout the several views. The exemplification set out herein illustrates an embodiment of the invention, and such exemplification is not to be construed as limiting the scope of the invention in any manner.

### DETAILED DESCRIPTION OF THE INVENTION

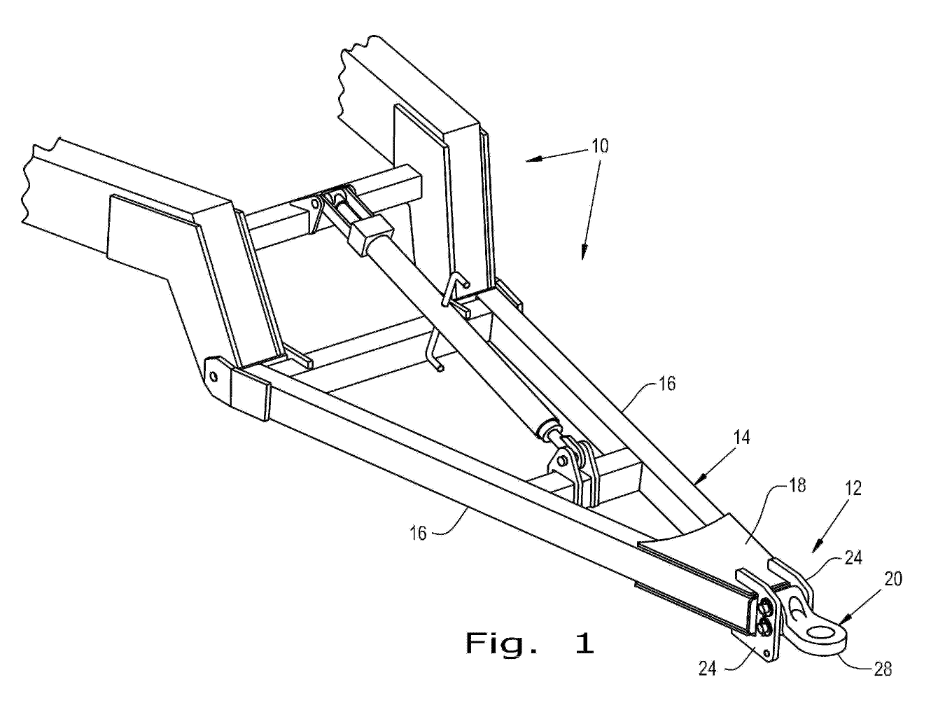

Referring now to the drawings, and more particularly to FIG. 1, there is shown a portion of the forward end of an agricultural implement 10, including an embodiment of a hitch assembly 12 of the present invention. In the illustrated embodiment, the agricultural implement 10 is assumed to be in the form of a disc ripper, such as the Case IH model 870 disc ripper which is manufactured and sold by the assignee of the present invention. However, it is to be understood that the hitch assembly 12 of the present invention may be used with different types of agricultural implements.

In general, implement 10 includes a pull frame 14 extending forward from the implement 10. Pull frame 14 is sized and configured to withstand pulling forces imparted by a traction unit, such as an agricultural tractor (not shown). More particularly, pull frame 14 includes two structural frame members configured as tubes 16 which are attached at a rear end thereof with the implement 10. Tubes 16 have a generally V configuration, in known manner, to withstand lateral forces during turning maneuvers, etc. The forward end of each tube 16 is connected with pull hitch assembly 12.

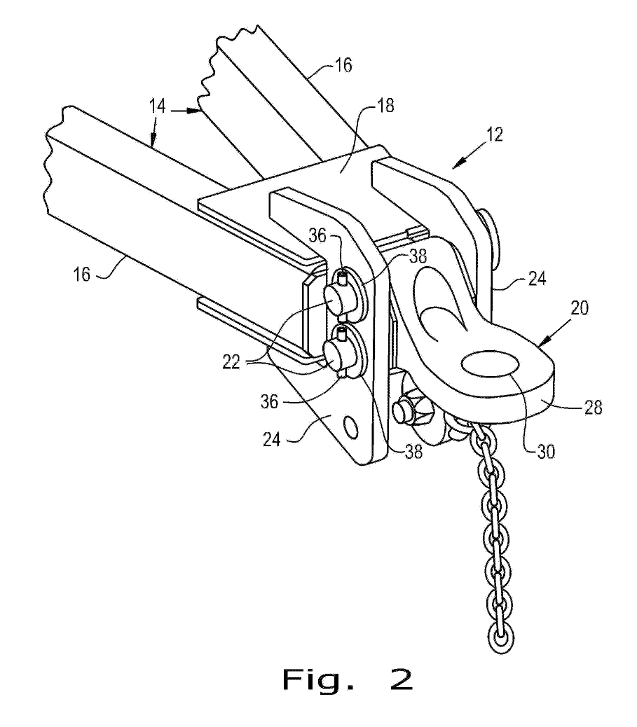

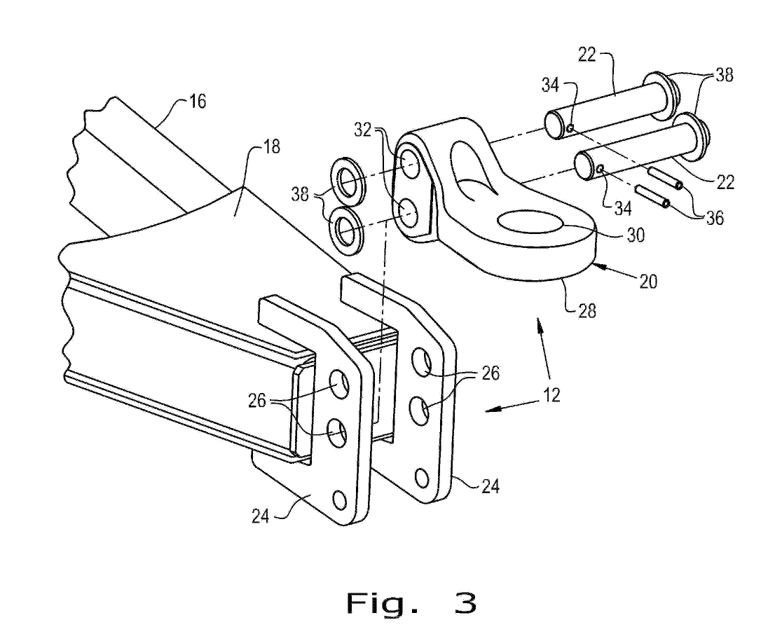

Pull hitch assembly 12 generally includes a pull hitch 18, clevis 20 and pins 22 (FIGS. 2 and 3). Pull hitch 18 is attached to a front end of the tubes 16 forming part of the pull frame 14. Pull hitch 18 includes a pair of hitch plates 24 spaced apart to receive the clevis 20 therebetween. The hitch plates 24 are generally vertically arranged, with each hitch plate 24 having one or more pairs of aligned openings 26 that are generally horizontally arranged. In the illustrated embodiment, each hitch plate 24 has two pairs of aligned openings 26 that are generally vertically arranged relative to each other, with each pair of aligned openings 26 being generally horizontally aligned with each other.

Clevis 20 is a cast iron clevis which couples with the drawbar (not shown) at the rear end of the traction unit. In the embodiment shown, clevis 20 has a single tongue 28 with a through hole 30 for receiving a hitch pin (not shown) therein; however, clevis 20 may also include a pair of tongues which are vertically spaced relative to each other such that the drawbar can fit between the tongues. Clevis 20 includes at least one pin opening 32, with each pin opening 32 sized to receive a respective hardened pin 22 therein. In the embodiment shown, clevis 20 includes two pin openings 32 for receiving respective hardened pins 22 therein.

Pins 22 are used to connect clevis 20 with pull hitch 18 in a stronger and simpler manner than previously possible, and are preferably case hardened pins. Each pin 22 extends through a pair of aligned openings 26 in pull hitch 18 and a corresponding pin opening 32 in clevis 20. Each pin 22 has a pair of crosswise retainer holes 34, with each retainer hole 34 being positioned at a respective axial end of pin 22. A pair of retainers, such as roll pins 36, are respectively positioned within each retainer hole 34. A pair of washers 38 are optionally associated with each pin 22, with each washer 38 being positioned between clevis 20 and a respective retaining pin 36.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural implement, comprising:
a pull frame extending forward from the implement;
a pull hitch attached to a front end of the pull frame, said pull hitch including at least one pair of aligned openings;
a clevis including at least one pin opening; and
at least one pin, each said pin extending through a pair of said aligned openings in said pull hitch and a corresponding said pin opening in said clevis.

2. The agricultural implement of claim 1, wherein said pull hitch includes a pair of hitch plates spaced apart to receive said clevis therebetween, and each of said pairs of aligned openings are formed in said hitch plates.

3. The agricultural implement of claim 2, wherein said hitch plates are generally vertically arranged and each of said pairs of aligned openings are generally horizontally arranged.

4. The agricultural implement of claim 1, wherein each said pin has a pair of crosswise retainer holes with each said retainer hole being positioned at a respective axial end of said pin, and further including a pair of retainers with each said retainer positioned within a respective said retainer hole.

5. The agricultural implement of claim 4, wherein each said retainer is a retaining pin.

6. The agricultural implement of claim 5, further including a pair of washers associated with each said pin, each said washer being positioned between said clevis and a respective said roll pin.

7. The agricultural implement of claim 1, wherein said clevis has a single tongue with a through hole for receiving a hitch pin therein.

8. The agricultural implement of claim 1, wherein said clevis is a cast clevis.

9. The agricultural implement of claim 1, wherein said at least one pair of aligned openings comprises two pair of aligned openings, said at least one pin opening comprises two pin openings, and said at least one pin comprises two pins.

10. The agricultural implement of claim 9, wherein said two pair of aligned openings are generally vertically arranged relative to each other.

11. The agricultural implement of claim 1, wherein said pins are case hardened pins.

12. A pull hitch assembly for an agricultural implement, the implement including a pull frame for pulling the implement with a traction unit, said pull hitch assembly comprising:
a pull hitch for attachment to a front end of the pull frame, said pull hitch including at least one pair of aligned openings;
a clevis including at least one pin opening; and
at least one pin, each said pin extending through a pair of said aligned openings in said pull hitch and a corresponding said pin opening in said clevis.

13. The pull hitch assembly of claim 12, wherein said pull hitch includes a pair of hitch plates spaced apart to receive said clevis therebetween, and each of said pairs of aligned openings are formed in said hitch plates.

14. The pull hitch assembly of claim 13, wherein said hitch plates are generally vertically arranged and each of said pairs of aligned openings are generally horizontally arranged.

15. The pull hitch assembly of claim 12, wherein each said pin has a pair of crosswise retainer holes with each said retainer hole being positioned at a respective axial end of said pin, and further including a pair of retainers with each said retainer positioned within a respective said retainer hole.

16. The pull hitch assembly of claim 15, wherein each said retainer is a retainer pin.

17. The pull hitch assembly of claim 16, further including a pair of washers associated with each said pin, each said washer being positioned between said clevis and a respective said roll pin.

18. The pull hitch assembly of claim 12, wherein said clevis is a cast clevis.

19. The pull hitch assembly of claim 12, wherein said at least one pair of aligned openings comprises two pair of aligned openings, said at least one pin opening comprises two pin openings, and said at least one pin comprises two pins, and wherein said two pair of aligned openings are generally vertically arranged relative to each other.

20. The pull hitch assembly of claim 12, wherein said pins are hardened pins.
